(19) United States
(12) Patent Application Publication
(10) Pub. No.: US 2026/0278547 A1
(43) Pub. Date: Sep. 17, 2026

(54) TECHNIQUES FOR CATEGORIZING AND DELIVERING QUERIES TO AN ARTIFICIALLY-INTELLIGENT AGENT ABOUT A USER GROUP USING CUSTOMIZED SEMANTIC INDEX BUNDLES

(71) Applicant: Visier Solutions, Inc., Vancouver (CA)

(72) Inventors: Ryan Hanna, Vancouver (CA); Ju Wu, Vancouver (CA); Patrick Cheng, Vancouver (CA)

(21) Appl. No.: 19/405,298

(22) Filed: Dec. 1, 2025

Related U.S. Application Data
(60) Provisional application No. 63/772,326, filed on Mar. 14, 2025.

(51) Int. Cl. G06Q 10/10; G06F 16/22; G06F 16/2458

(52) U.S. Cl. CPC G06Q 10/10; G06F 16/22; G06F 16/2458

(57) ABSTRACT

An example method includes obtaining a textual prompt at a user interface associated with a productivity application. The method includes identifying a query based on content of the textual prompt. The method includes, based on analyzing the query, determining whether the query is a detail-seeking query, requesting data currently available within multiple data sources associated with the productivity application, or a panoptic query requesting another set of data that is not currently available within the productivity application and requires aggregation of multiple data sources. The method includes, based on a first determination that the query is the detail-seeking query, providing the set of data to a large-language model. The method includes identifying another query within the textual prompt. The method includes, when a second determination that the other query is the panoptic query, providing data from the multiple data sources to another LLM to perform an analytical function.

### CROSS-REFERENCE TO RELATED APPLICATIONS

This application claims priority to U.S. Prov. App. No. 63/772,326, filed on Mar. 14, 2025, titled “Techniques for Categorizing and Delivering Queries to an Artificially-Intelligent Agent about a User Group Using Customized Semantic Index Bundles,” which is incorporated herein by reference in its entirety.

### TECHNICAL FIELD

This relates generally to workforce management applications, and specifically to workforce management applications for categorizing and delivering queries to an artificially-intelligent (AI) agent about a user group to optimize the ability to generate results by the AI agent based on the category of the queries.

### BACKGROUND

Workforce management requires frequent and complex analysis about aspects of the workforce, including members of the workforce, which may be based on data collected from various workforce applications (e.g., productivity applications) that the member of the workforce used during performance of their work. AI is gaining popularity, and can be used to perform analytical tasks, such as analyzing information about a workforce. AI can be difficult to use for analyzing copious amounts of data, and can also present issues related to data privacy and data access.

### SUMMARY

In the disclosed embodiments, systems and methods are provided for addressing challenges in efficiently analyzing data about a workforce, including data related to a set of workforce applications that are used by members of the workforce during performance of their work functions. Such analysis is difficult and time-consuming to process, as a result of the sheer amount of data and data schemas inherent in such systems. Further, the data about the workforce may have varying degrees of relevance as a result of its recency. For example, data relevant to a user quarterly and/or yearly performance may be the more recent data. And the disclosed embodiments describe discrete tracks for distinct types of queries. In addition to categorizing queries based on particular topics (e.g., compensation, human resources), the disclosed embodiments can also be configured to determine whether a particular query is a detail-seeking query (e.g., specific information that is already available for retrieval within the system) or a panoptic query (e.g., requiring aggregated analysis), which can allow for the most relevant information to be provided to an AI model being used to respond to the query.

The disclosed embodiments include various technical improvements as compared to existing systems, including various security and data integrity aspects. For example, embodiments discussed herein can be configured to provide secure query formulation that ensures that sensitive data of the company is not provided to any of the AI models, including a foundational LLM of the system, which is ensured by the way that the system is configured to formulate queries based on the input provided by the user. In some embodiments, the system is configured to improve data integrity by preventing “hallucinations,” an issue associated with LLMs that can cause them to artificially create data that is ultimately provided to a user-facing device, in accordance with some embodiments. That is, although the LLM may, in certain instances, misinterpret a natural language question and generate an incorrect analytical query, the analytical model will consistently return the correct data corresponding to that specific (albeit potentially misinterpreted) query. The techniques disclosed herein also include improvements in security of the workforce management applications described by including security layers that carefully and specifically control users’ access to data, including through interactions with the AI models (e.g., the foundational LLM), including by providing specific levels of access to users based on their respective roles within the workforce.

The disclosed embodiments also provide user interface (UI) integrations that can allow users to perform queries within workforce applications that the users are already using to perform workforce related tasks. By doing so, the disclosed embodiments provide users with more efficient options for performing queries without having to navigate through other applications and other user interfaces that they are not expected to be familiar with as part of their job function.

An example method is provided, in accordance with some embodiments. The example method is performed at an electronic device associated with a workforce management application, the electronic device having one or more processors and memory. The example method includes obtaining a textual prompt at a user interface associated with a productivity application. The example method includes identifying, based on content of the textual prompt, a query within the textual prompt. The method includes, based on analyzing the query, determining whether the query is one of (i) a detail-seeking query type, requesting a set of data that is currently available within one or more respective data sources associated with the productivity application, or (ii) a panoptic query requesting another set of data that is not currently available within the productivity application and requires aggregation of two or more respective data sources associated with the productivity application. The method includes, in accordance with a first determination that the query is the detail-seeking query, providing the set of data to a large-language model (LLM) to format an answer based on an attribute or metric from the set of data. The method includes identifying, based on other content of another textual prompt, another query within the textual prompt; and in accordance with a second determination that the other query is the panoptic query requires the other set of data that is not currently available, providing respective data from the two or more respective data sources to another LLM to perform an analytical function on the respective data from the two or more respective data sources.

In accordance with some embodiments, an electronic device is provided. The electronic device includes one or more processors and memory storing one or more programs. The one or more programs include instructions for performing any of the methods described herein.

In accordance with some embodiments, a non-transitory computer-readable storage medium is provided. The non-transitory computer-readable storage medium stores one or more programs for execution by an electronic device with one or more processors. The one or more programs comprise instructions for performing any of the methods described herein.

Thus, methods and associated devices and systems are provided for facilitating user interactions with a workforce-management application.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 shows block diagrams illustrating a workforce management system, in accordance with some embodiments.

FIG. 2 is a block diagram illustrating an electronic device associated with a workforce provider, in accordance with some embodiments.

FIG. 3 is a block diagram illustrating a remote server of a workforce-management system, in accordance with some embodiments.

FIGS. 4A to 4D are sequence diagrams illustrating user interfaces and operations of an example workforce-management application, in accordance with some embodiments.

FIGS. 5A to 5E are sequence diagrams illustrating user interfaces and operations of an example workforce-management application, in accordance with some embodiments.

FIG. 6 is a flow diagram illustrating an example method performed by an example workforce management application, in accordance with some embodiments.

FIG. 7 is a logic diagram illustrating an example method for disambiguating and processing queries to an AI model of a workforce management application, in accordance with some embodiments.

FIGS. 8A to 8C include a network diagram indicating an example embodiment of a user input being provided to a workforce management application being executed at a customer’s electronic device (e.g., a network server, an administrator or employee’s electronic device), in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

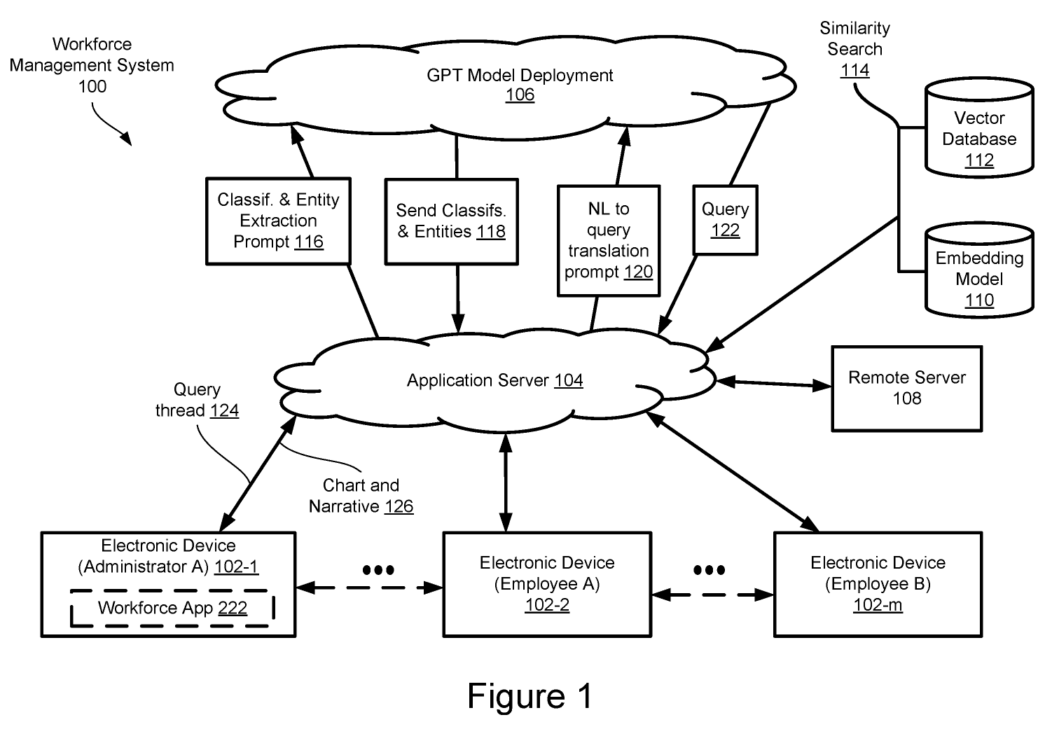

FIG. 1 is a block diagram illustrating a workforce management system 100, in accordance with some embodiments. The workforce management system 100 includes one or more electronic devices 102 (e.g., electronic device 102-1 associated with an administrator of the workforce management application, electronic device 102-2 associated with a first employee of the management application, and/or electronic device 102-3 associated with a second employee of the workforce management application), one or more remote servers (e.g., an application server 104, a GPT model deployment server 106, and/or another remote server 108, which may be associated with a third-party productivity application), and/or one or more data sources in electronic communication with the workforce management system 100 (e.g., databases located at, or otherwise in electronic communication with, the remote server 108, an embedding model database 110, and/or a vector database 112). One or more networks (e.g., wired and/or wireless networks) may be used to communicably couple the components of the workforce management system 100.

In some embodiments, an electronic device 102 is associated with a particular productivity application (e.g., a document editing application, an email management application, an internal messaging application, and/or a combinational service, and/or a company associated with a plurality of distinct workforce management providers). In some embodiments, when the electronic device 102 associated with the particular workforce management provider forms an electronic communication with the application server 104, a particular set of data objects (e.g., one or more rows in a MongoDB database, one or more data structures from a JavaScript Object Notation (JSON) data store) associated with the workforce management application is accessed via the application server 104 and provided to the electronic device 102 (e.g., via a data object stored within a network response). For example, the electronic device 102-1 may provide a query thread 124 from a user interface presented by the workforce management application, and the application server may provide outputs (e.g., a textual response, a chart and/or narrative response 126) to the electronic device).

In accordance with some embodiments, the application server 104 communicates with the GPT model deployment server 106. For example, the application server 104 may provide a classification and entity extraction prompt 116 to the GPT model deployment server 106 and receives classifications and entities 118 from the GPT model deployment server 106. And the application server 104 can provide a natural language to query translation prompt 120 to the GPT model deployment server 106 and may receive a query 122 from the GPT model deployment server 106.

Electronic devices 102 may connect to each other wirelessly and/or through a wired connection (e.g., directly through an interface, such as an HDMI interface). In some embodiments, electronic devices 102-1 and 102-m are the same type of device (e.g., electronic device 102-1 and electronic device 102-m are both speakers). Alternatively, electronic device 102-1 and electronic device 102-m include two or more distinct types of devices.

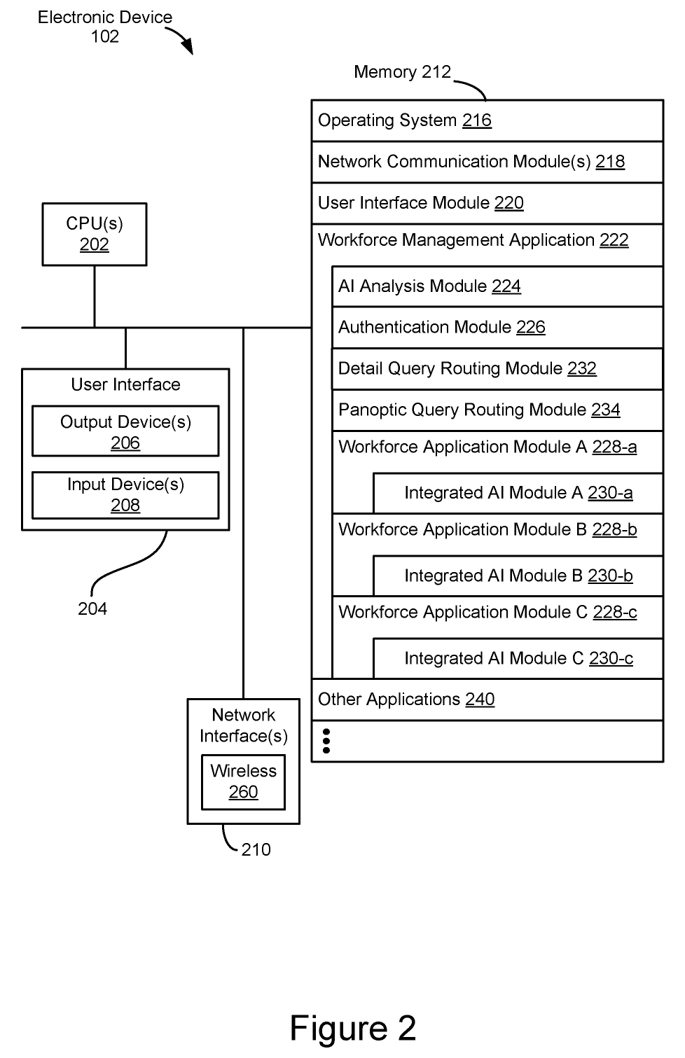

FIG. 2 is a block diagram illustrating an electronic device 102 (e.g., electronic device 102-1 and/or electronic device 102-m; FIG. 1) associated with a workforce management application , in accordance with some embodiments.

The electronic device 102 includes one or more central processing units (e.g., CPU(s), i.e., processors or cores) 202, one or more network (or other communications) interfaces 210, memory 212, and one or more communication busses for interconnecting these components. The one or more communication busses 214 optionally include circuitry (sometimes called a chipset) that interconnects and controls communications between system components. In some embodiments, the network interfaces 210 include one or more wireless interfaces 260, which may be used to communicate with a remote server (e.g., the application server 106) to access database objects associated with respective entities within the workforce.

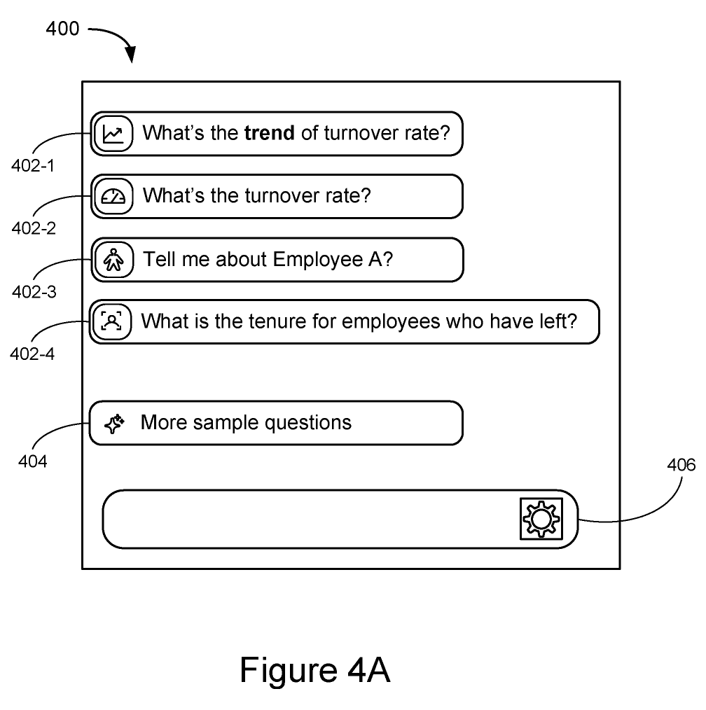

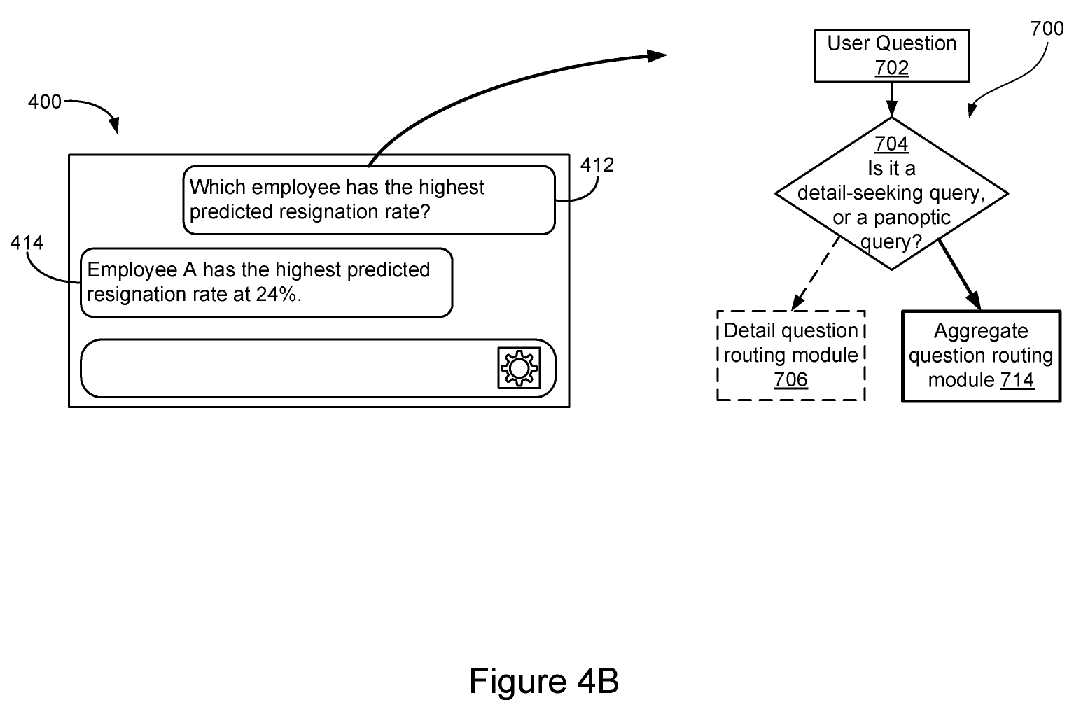

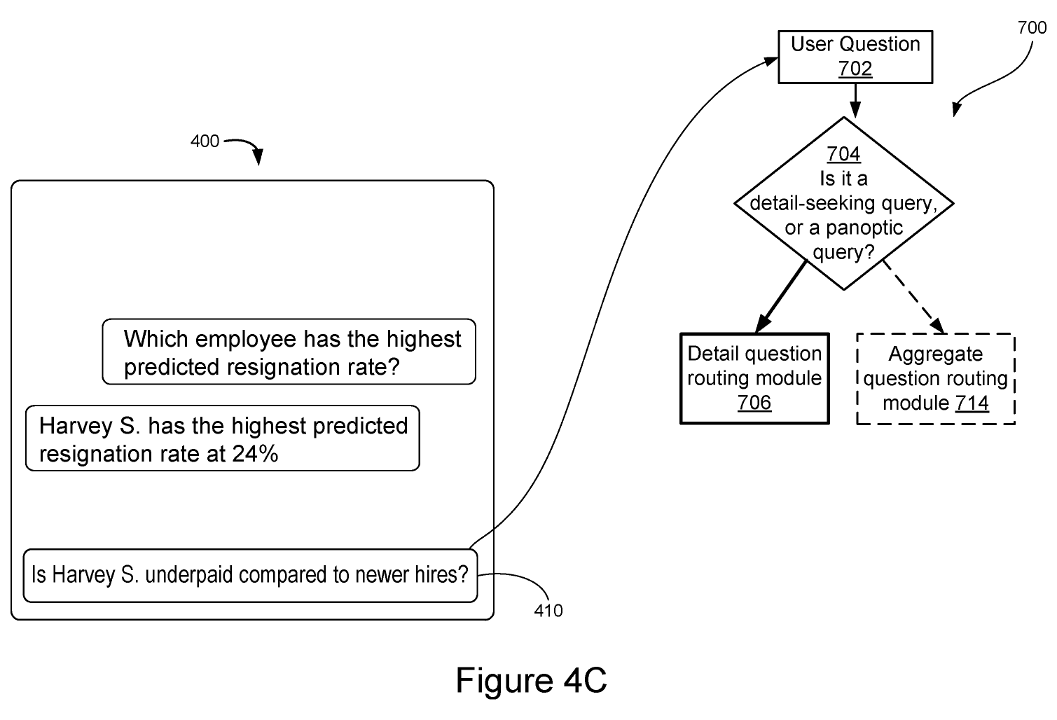

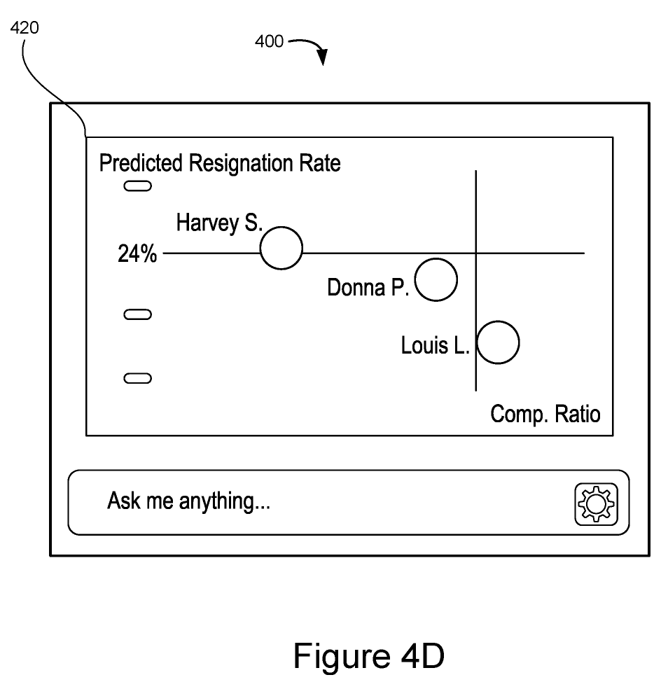

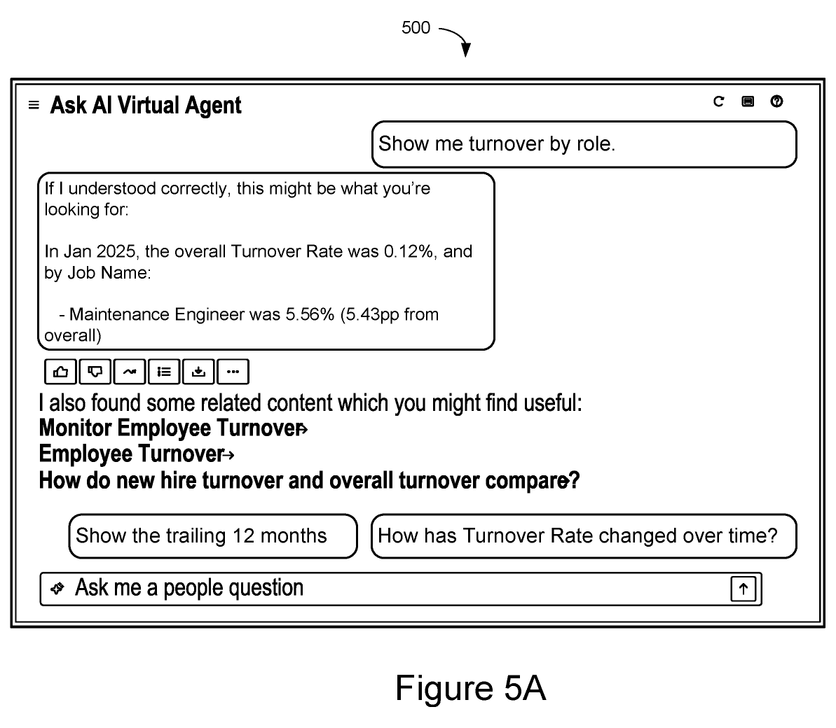

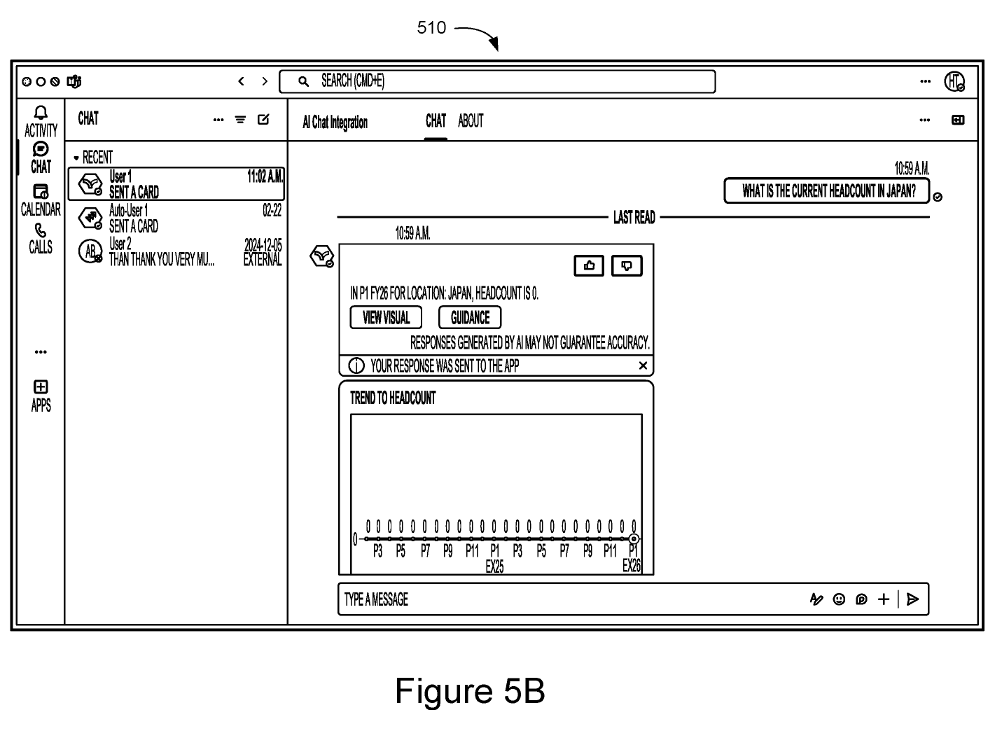

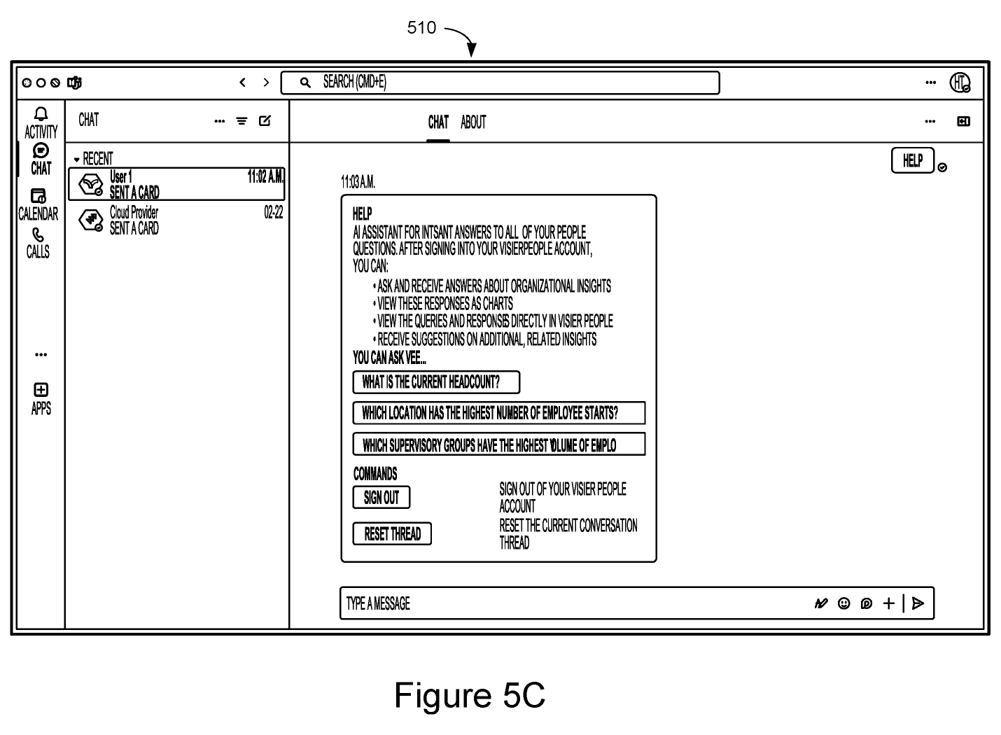

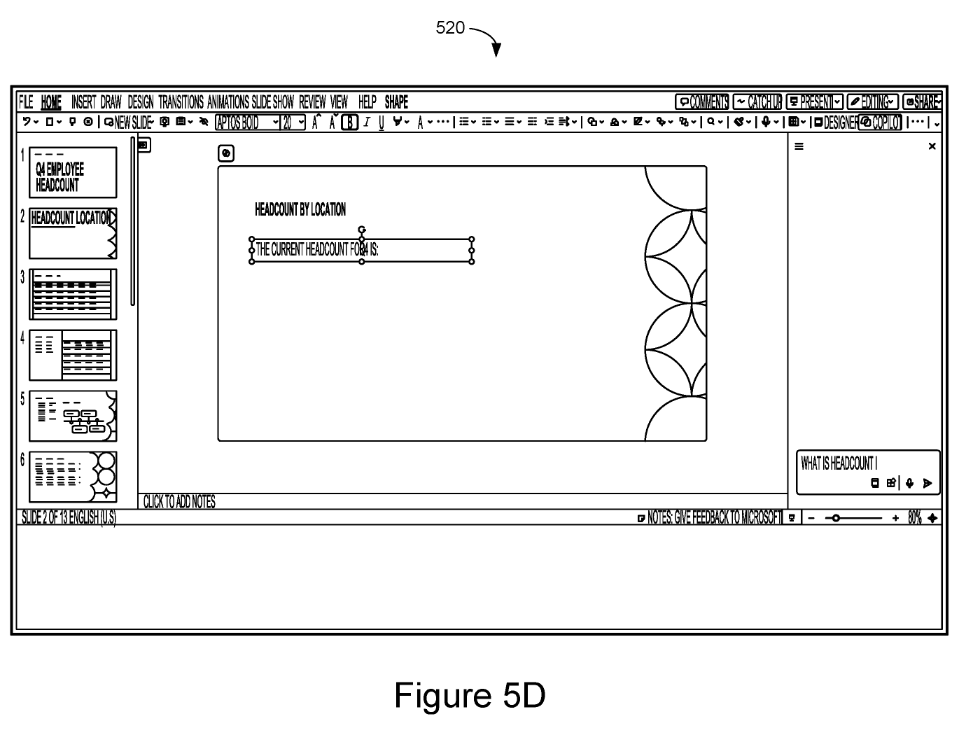

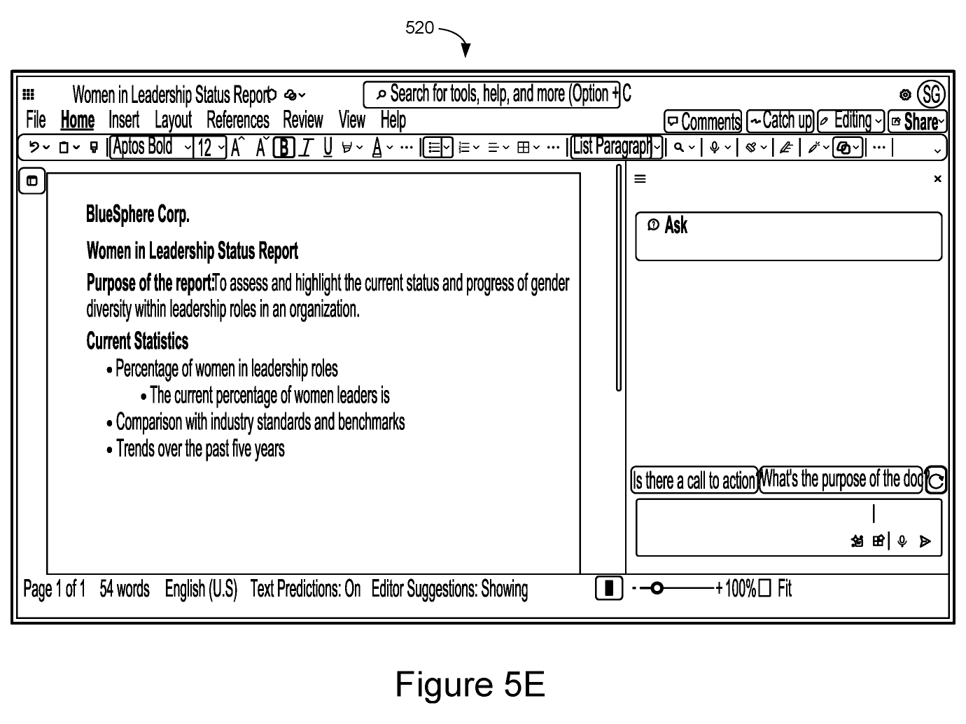

In some embodiments, the electronic device 102 includes a user interface 204, including output device(s) 206 and/or input device(s) 208. In some embodiments, the input devices 208 include a keyboard, a mouse, and/or a track pad. In some embodiments, input devices 208 include a camera (e.g., a webcam) that captures images within a field of view adjacent to the electronic device 102. Alternatively, or in addition, in some embodiments, the user interface 204 includes a display device that includes a touch-sensitive surface (e.g., when the display device is a touch-sensitive display). In some embodiments, the output devices (e.g., output device(s) 206) include a speaker (e.g., speakerphone device) and/or an audio jack (or other physical output connection port) for connecting to speakers, earphones, headphones, or other external listening devices. Optionally, the electronic device 102 includes an audio input device (e.g., a microphone) to capture audio (e.g., speech from a user). In some embodiments, one or more user interfaces of the electronic device 102 (e.g., a touch-sensitive display) can be used to present user interfaces of the workforce-management application (e.g., user interfaces for facilitating various interactions with the workforce management application as described in more detail with respect to FIGS. 4A to 4D and 5A to 5E).

Optionally, the electronic device 102 includes a location-detection device 240, such as a global navigation satellite system (e.g., GPS (global positioning system), GLONASS, Galileo, BeiDou) or other geo-location receiver, and/or location-detection software for determining the location of the computer system 102 (e.g., a module for finding a position of the computer system 102 using trilateration of measured signal strengths for nearby devices).

Memory 212 includes high-speed random-access memory, such as DRAM, SRAM, DDR RAM, or other random-access solid-state memory devices, and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:

an operating system 216 that includes procedures for handling various basic system services and for performing hardware-dependent tasks;

network communication module(s) 218 for connecting the computer system 102 to other computing devices;

a user interface module 220 that receives commands and/or inputs from a user via the user interface 204 (e.g., from the input devices 208) and provides outputs for, e.g., display on the user interface 204 (e.g., the output devices 206);

a workforce-management application 222 for providing analytic and other capabilities to a user about a respective workforce including, but not limited to, one or more of:

an AI analysis module 224 for receiving queries from a user and providing responses based on providing information about the user query to an AI model;

an authentication module 226 for determining whether a user has access to respective components and data of the workforce management application 222;

a set of workforce application modules 228 (e.g., a first productivity module 228-a, a second productivity module 228-b, a third productivity module 228-c), which may each include respective integrated AI modules 230-a, 230-b, and 230-c);

other applications 240, such as applications for word processing, calendaring, mapping, weather, stocks, time-keeping, virtual digital assistant, presenting, number crunching (spreadsheets), drawing, instant messaging, email, telephone, video conferencing, photo management, video management, etc.

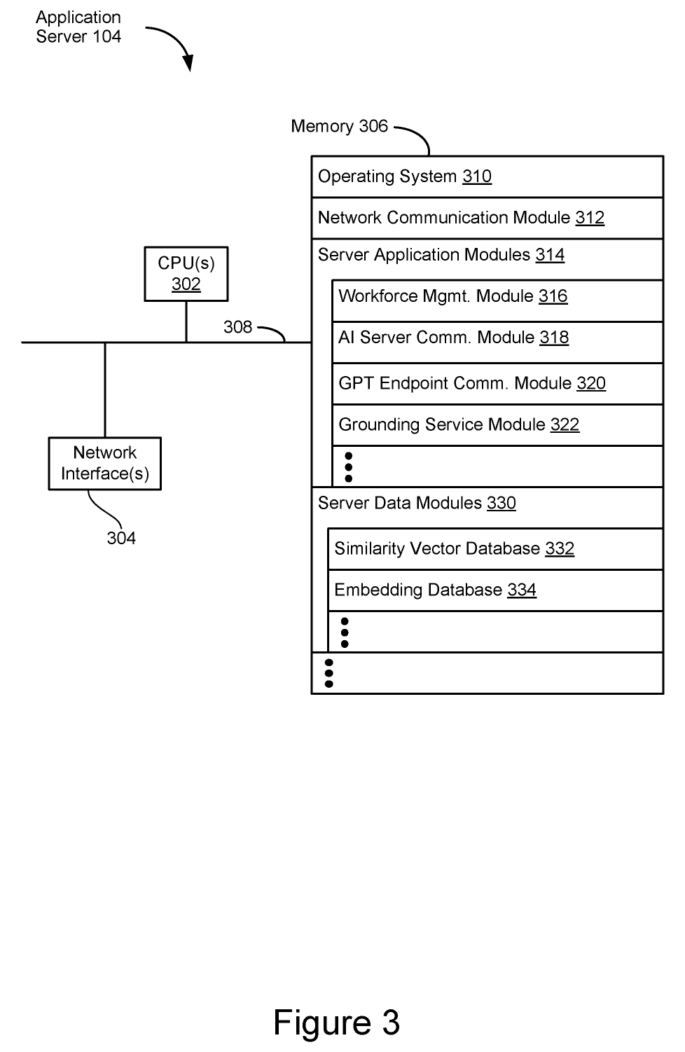

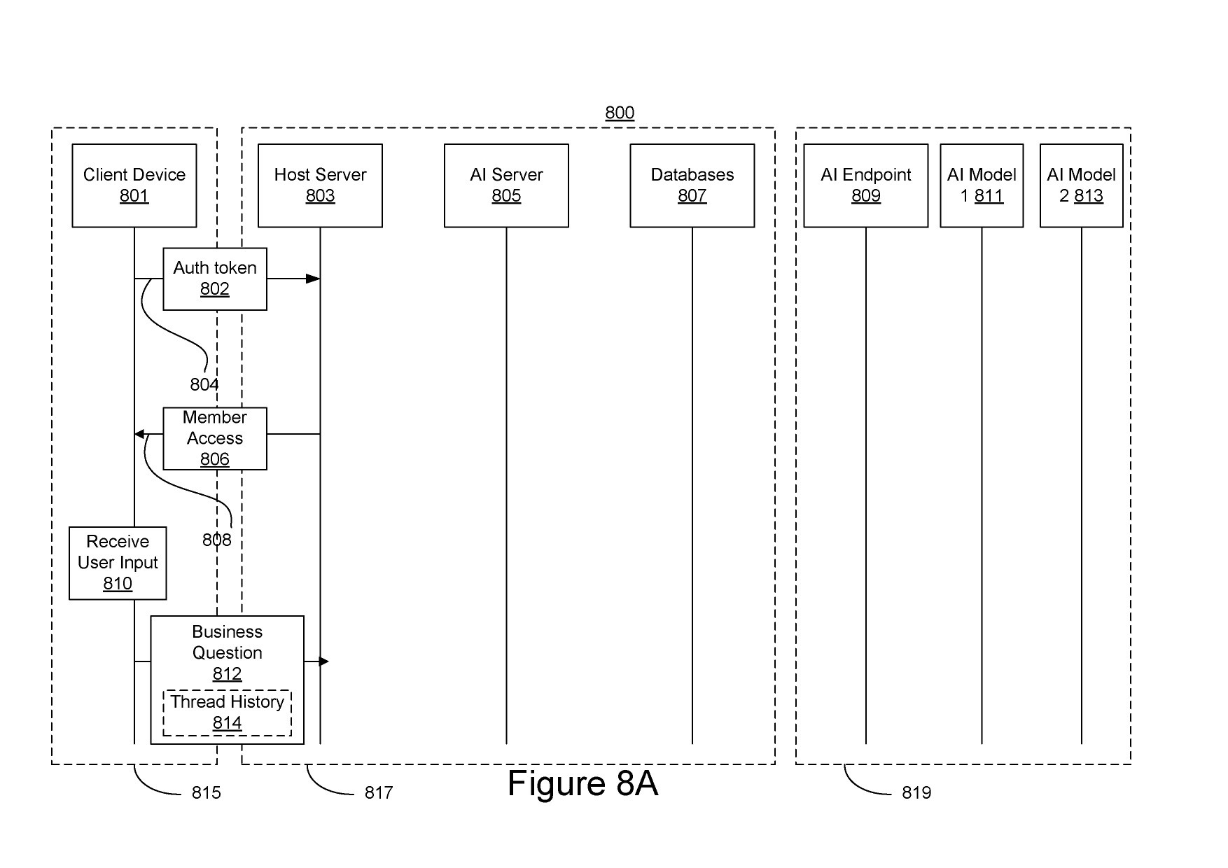

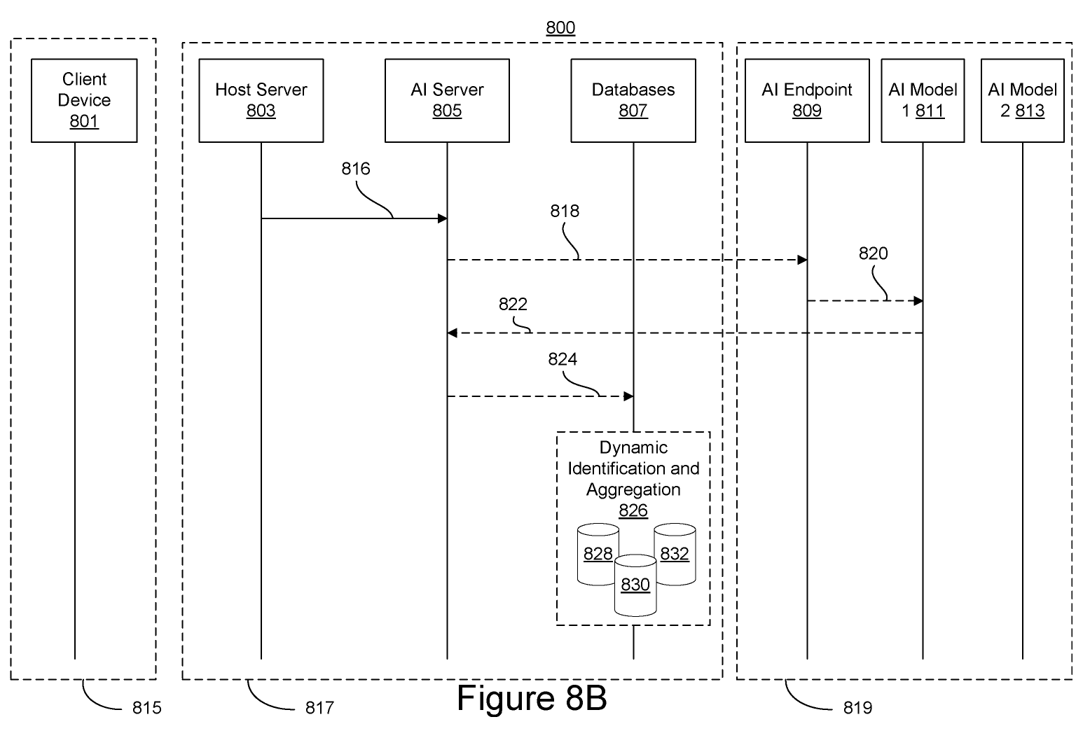

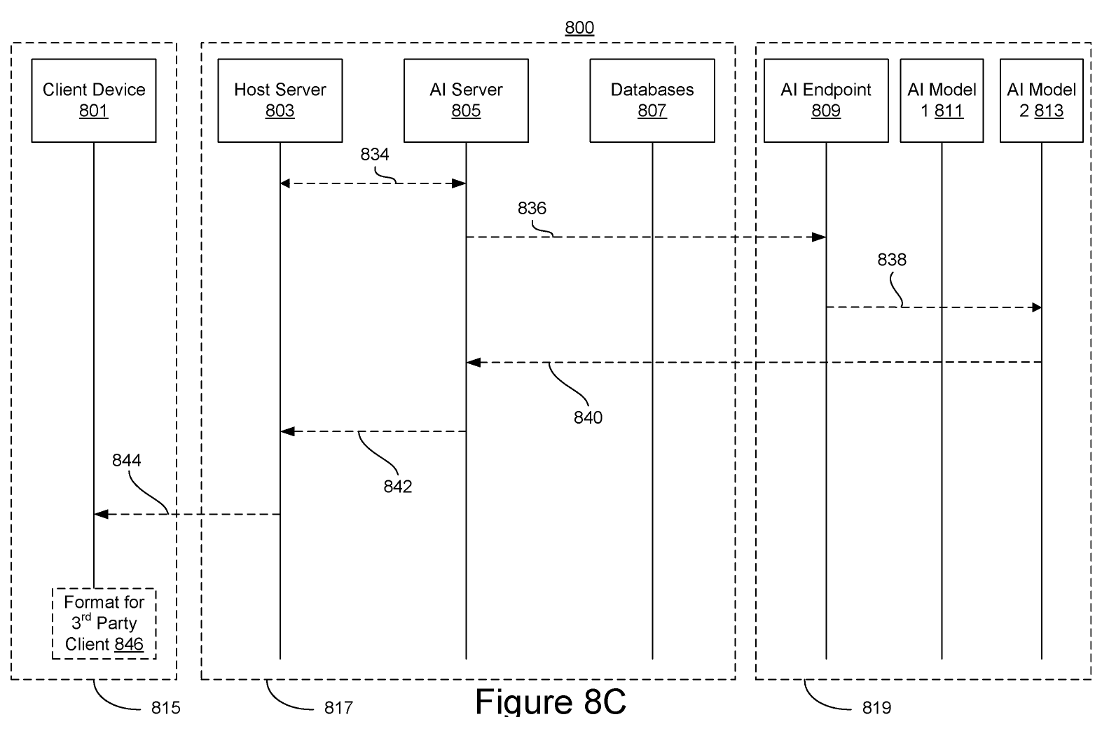

FIG. 3 is a block diagram illustrating an application server 104 of the workforce management system 100, in accordance with some embodiments. In some embodiments the application server 104 can be the host server 803 or the AI server 805 shown in FIGS. 8A to 8C. In some embodiments, the AI endpoint 809 can include or more components, or be a part of, the application server 104.

Memory 306 includes high-speed random-access memory, such as DRAM, SRAM, DDR RAM, or other random access solid-state memory devices, and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof:

an operating system 310 that includes procedures for handling various basic system services and for performing hardware-dependent tasks;

a network communication module 312 that is used for connecting other computing devices via one or more network interfaces 304 (wired or wireless);

one or more server application modules 314 for performing various functions with respect to providing and managing a content service, the server application modules 314 including, but not limited to, one or more of:

a workforce-management module 316 for facilitating interactions between respective workforce providers and the workforce-management application while it is being caused to be executed at an electronic device 102-1; and

an AI server communication module 318 for communicating between the application server 104 and one or more AI servers and/or AI endpoints;

a GPT endpoint communication module 320 for communicating between the application server 104 and one or more GPT AI model endpoints (e.g., GPT 3.5, GPT 4.0); and

a grounding service module 322 for performing grounding operations at the application server 104, including generating one or more semantic index bundles relevant to user queries provided to the application server 104;

one or more server data module(s) 330 for handling the storage of and/or access to data relating to the provision of secure computer sessions; in some embodiments, the one or more server data module(s) 330 include:

One or more similarity vector databases 332 for identifying relationships between queries that the user is performing and data accessible to the application server 104 (e.g., semantic index bundles generated based on data schemas within the system); and

An embedding database 334 for storing embeddings based on relationships between data accessible or otherwise in electronic communication with the application server 104.

In some embodiments, the remote server 108 includes web or Hypertext Transfer Protocol servers, File Transfer Protocol servers, as well as webpages and applications implemented using Common Gateway Interface script, PHP Hyper-text Preprocessor, Active Server Pages, Hyper Text Markup Language (HTML), Extensible Markup Language (XML), Java, JavaScript, Asynchronous JavaScript, and XML, XHP, Javelin, Wireless Universal Resource File, and the like.

Each of the above identified modules stored in memory 212 and 306 corresponds to a set of instructions for performing a function described herein. The above identified modules or programs (i.e., sets of instructions) need not be implemented as separate software programs, procedures, or modules, and thus various subsets of these modules may be combined or otherwise rearranged in various embodiments. In some embodiments, memory 212 and 306 optionally store a subset or superset of the respective modules and data structures identified above. Furthermore, memory 212 and 306 optionally store additional modules and data structures not described above.

Although FIG. 3 illustrates the remote server 108 in accordance with some embodiments, FIG. 3 is intended more as a functional description of the various features that may be present in one or more remote servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers used to implement the remote server 108, and how features are allocated among them, will vary from one embodiment to another and, optionally, depends in part on the amount of data traffic that the server system handles during peak usage periods as well as during average usage periods.

FIGS. 4A to 4D are sequence diagrams illustrating user interfaces and operations of an example workforce-management application, in accordance with some embodiments. In accordance with some embodiments, each of the respective user interfaces shown in FIGS. 4A to 4D are associated with the workforce management system 100. In some embodiments, the user interfaces shown in FIGS. 4A to 4D are not natively configured to implement functions of the workforce management system 100, and those features are installed at the respective applications that are being used in conjunction with the presenting of the respective user interfaces.

FIG. 4A shows a first user interface 400 for interacting with a workforce management application that includes a plurality of user interface elements 402 for providing prompts to an AI agent. In some embodiments, an AI system associated with the workforce management application is configured to generate pre-defined prompts based on aspects of the database and/or user behavior, as shown by the plurality of user interface elements 402 (e.g., a first prompt 402-1 stating “What’s the trend of turnover rate?”; a second prompt 402-2 stating “What’s the turnover rate?”; a third prompt 402-3 stating “Tell me about employee A”; a fourth prompt 402-4 stating “What is the tenure for employees who have left?”; and a fifth prompt stating “More sample questions”). In some embodiments, an administrator of the system is able to input prompt templates that can be used by the system to produce pre-defined prompts to present at user interfaces, such as the user interface 400. In accordance with some embodiments, the user interface 400 in FIG. 4A includes a selectable user interface element 404 for causing another set of user interface elements including different predefined query options. The user interface 400 also includes a text input user interface element 406 for receiving input text from a user.

FIG. 4B shows another user interface 400 after the user has provided a query to the AI system. In accordance with some embodiments, the user’s prompt is provided to the AI system 700, and the AI system 700 determines whether the query is a detail-seeking query or a panoptic query. Based on a first determination that the query shown in FIG. 4B (“Which employee has the highest predicted resignation rate?”) is a panoptic query, the query is provided to the aggregate question routing module 714. In some embodiments, when the AI system determines that a query is a panoptic query, and indication is provided at the user interface 400 that indicates that the query may take more time to resolve.

FIG. 4C shows another query being provided by the user at the query input 410 of the user interface 400. In accordance with some embodiments, when the user provides another prompt, the AI system 700 again determines whether the query is a detail-seeking query or a panoptic query based on the content of the prompt provided from the user. Based on a second determination that the query shown in FIG. 4C is a detail-seeking query, the query is provided to the detail query routing module 706, in accordance with some embodiments.

FIG. 4D shows another output being provided at the user interface 400 where a visual output object 420 is provided in response to a user input. In some embodiments, the application server 104 receives an output from an AI model and/or an AI server (e.g., the AI models 811 and 813 shown in FIGS. 8A to 8C).

FIGS. 5A to 5E are sequence diagrams illustrating user interfaces and operations of an example workforce-management application, in accordance with some embodiments.

FIG. 5A shows an example of the user interface 400 shown in FIGS. 4A to 4D, after the user has provided various user inputs in a conversation with an AI virtual agent associated with the workforce management application.

FIGS. 5B and 5C show an example user interface 510 of a workforce application module 228 (e.g., an email management application), which can be configured to be integrated with an AI model of the workforce management system 100 (e.g., an integrated AI module 230-a). This can allow for the user of the email management application to interact with the AI model without opening another application, such as the workforce management application 400.

FIGS. 5D and 5E show an example of another user interface of another workforce application module 228 (e.g., a presentation slide creation application), which can be configured to be integrated with an AI model of the workforce management system 100 (e.g., an integrated AI module 230-b).

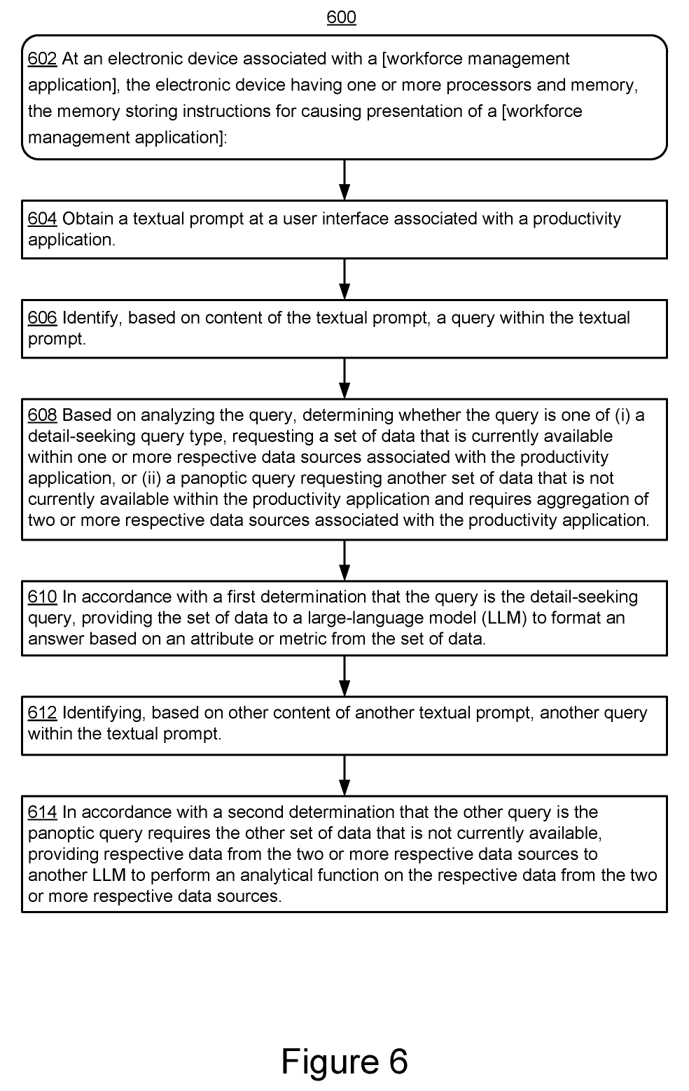

FIG. 6 is a flow diagram illustrating an example method 600 performed by an example workforce management application, in accordance with some embodiments. For ease of description, the following embodiments are described in terms of the methods, systems, and devices above with respect to FIGS. 1 and 5E. The one or more operations of the method 600 may be implemented, for example, by the electronic device 102-1 associated with the particular workforce member (e.g., an administrator).

(A1) In some embodiments, the method 600 is performed at an electronic device (e.g., associated with a workforce management application), the electronic device having one or more processors and memory, the memory storing instructions for causing presentation of user interfaces associated with a workforce management application (602).

In accordance with some embodiments, the computing device 102-1 is configured to obtain (604) a textual prompt at a user interface associated with a productivity application.

In accordance with some embodiments, the computing device 102-1 is configured to identify (606), based on content of the textual prompt, a query within the textual prompt.

In accordance with some embodiments, the computing device 102-1 is configured to, based on analyzing the query, determining (608) whether the query is one of (i) a detail-seeking query type, requesting a set of data that is currently available within one or more respective data sources associated with the productivity application, or (ii) a panoptic query (e.g., a query require a comprehensive data analysis) requesting another set of data that is not currently available within the productivity application and requires aggregation of two or more respective data sources associated with the productivity application.

In accordance with some embodiments, the computing device 102-1, in accordance with a first determination that the query is the detail-seeking query, providing (610) the set of data to a large-language model (LLM) to format an answer based on an attribute or metric from the set of data.

In accordance with some embodiments, the computing device 102-1 identifies (612) based on other content of another textual prompt, another query within the textual prompt. For example, in accordance with some embodiments, the system can identify a prompt to provide to the system based on the text that the user provides at a user input being presented by the user interface 400.

In accordance with some embodiments, the computing device 102-1, in accordance with a second determination that the other query is the panoptic query requires the other set of data that is not currently available, provides (614) respective data from the two or more respective data sources to another LLM to perform an analytical function on the respective data from the two or more respective data sources.

(A2) In some embodiments of A1, the computing device, in accordance with the second determination that the query is the panoptic query, provides additional context data to the LLM from one or more of: (i) a vector database, (ii) an embedding model, and (iii) usage data.

(A3) In some embodiments of A1 or A2, the determination whether the query is the detail-seeking query further comprises determining whether the query is (i) answerable with stored attributes, and/or (ii) answerable with available metrics.

(A4) In some embodiments of A1 to A3, the LLM and the other LLM comprise different models. For example, in some embodiments, detail-seeking queries are provided to a deployment of a GPT 3.5 model, and panoptic queries are provided to a deployment of a GPT 4 model.

(A5) In some embodiments of A1 to A4, the computing device 102-1, in accordance with the second determination that the query is the panoptic query, generates an index bundle based on the respective data from the two or more respective data sources that is to be provided to the other LLM.

(A6) In some embodiments of A1 to A5, the two or more respective data sources are each associated with distinct productivity applications that are used by a plurality of employees of a work force.

(A7) In some embodiments of A1 to A6, the computing device 102-1, after providing the set of data to the LLM to format the answer based on the attribute or the metric from the set of data, identifies a set of predefined panoptic queries related to the answer. In some embodiments, the computing device 102-1 presents a set of user interface elements associated with one or more respective predefined panoptic queries of the set of predefined panoptic queries.

(A8) In some embodiments of A1 to A7, the computing device 102-1, after providing the respective data from the two or more respective data sources to the other LLM to perform the analytical function on the respective data from the two or more respective data sources, causes presentation of a visual representation provided as an output of the other LLM based on the result of the analytical function performed on the respective data.

(A9) In some embodiments of A1 to A8, the computing device 102-1, after identifying the query within the textual prompt, determines whether one or more previous textual prompts within a thread associated with the user interface are related to the query. In some embodiments, based on a determination that the one or more previous textual prompts are related to the query, the computing device 102-1 uses data associated with the previous textual prompts to determine whether the query is a detail-seeking query or a panoptic query.

(B1) In accordance with some embodiments, a non-transitory, computer-readable storage medium including executable instructions that, when executed by one or more processors, cause the one or more processors to perform or cause performance of the method of any one of A1 to A9.

(C1) In accordance with some embodiments, a means is provided for performing or causing performance of the methods of any one of A1 to A9.

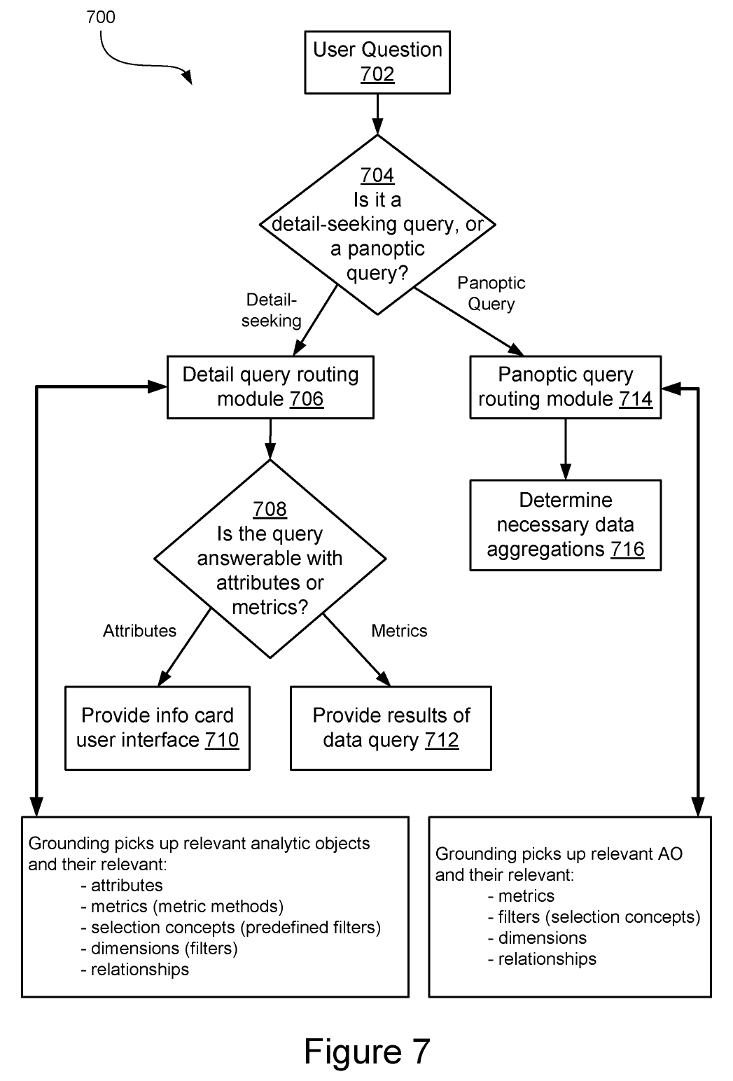

FIG. 7 is a logic diagram illustrating an example method 700 for disambiguating and processing queries to an AI model of a workforce management application, in accordance with some embodiments.

First, the workforce management application (e.g., the workforce management application 400) receives a user question (Step 702). For example, FIG. 4B shows a user question being received at the user interface 400 of the workforce-management application 100.

After receiving the prompt, the workforce management application determines whether the user question is a detail query, or an aggregate query (Step 704).

In accordance with a first determination that the question is a detail-seeking query, the system provides the query to a detail question routing module (e.g., detail question routing module 232 in FIG. 2) (Step 706).

After determining that the particular user question is a detail-seeking query, the system is configured to determine whether the question is answerable with attributes or metrics (Step 708).

In some embodiments, in accordance with a first determination that the query is answerable with attributes, the system causes presentation of an info card user interface (Step 710).

In some embodiments, in accordance with a second determination that the query is answerable with metrics, the system provides results of a data query (Step 712).

After determining that a particular user question is a panoptic query that requires aggregation from multiple data sources, the system provides the query to a panoptic query routing module (e.g., panoptic query routing module 234 in FIG. 2) (Step 714).

After providing the query to the panoptic query routing module, the system determines necessary data aggregations (Step 716). In some embodiments, the system determines whether further index bundle generation is needed as part of performing the necessary data aggregations.

FIGS. 8A to 8C include a network diagram indicating an example embodiment of a user input being provided to a workforce management application 800 being executed at an electronic device (e.g., a network server, an administrator or employee’s electronic device 102). The network diagram of the workforce management application 800 includes various components, such as a client device 801 (which may be an example of the electronic device 102), a host server 803, an AI server 805, databases 807, and AI endpoint 809, a first AI model 811, and a second AI model 813. But a skilled artisan will appreciate that other components not shown may be part of the workforce management system 800. As shown by FIGS. 8A to 8C, distinct aspects of the system can be located in separate locations, such as a customer device 815, a production server 817, and a remote server 819.

Starting with FIG. 8A, step 804 shows an authentication request, including passing an authentication token 802 from the client device 802 to the application server 804. In response to the authentication request, an indication of authentication is provided back to the client device 801 (step 808), including an indication of member access 806 of the user. In some embodiments the user authentication is specific to the user performing the authentication request (e.g., based on their role and/or relationship(s) with other members of workforce).

After the authentication (or before, in accordance with some embodiments) a user input 810 is received at the client device. Based on the user input 810, a business question 812 is provided to the application server 803, including thread history 814, in accordance with some embodiments. In some embodiments, application server 803 sends a request to get a status of one or more index bundles relevant to the business question 812. In some embodiments, in accordance with determining that one or more index bundles needs to be updated, the host server 803 sends data to the AI server 805 to cause the index bundle to be updated. In some embodiments, the host server 803 sends terms to be resolved to the AI server 805 in conjunction with or after determining the business question 812.

Turning to FIG. 8B, based on the business question 812 and/or thread history 814, the host server 803 provides a request 816 to the AI server 805 to answer the business question. In accordance with some embodiments, based on receiving the request 816, the AI server 805 sends a request 818 to an AI endpoint 809, which may be an initial routing and question analysis prompt.

Based on receiving the request 818, the AI endpoint 809 sends a request 820 to the first AI model 811. The output of the AI model 811, including routing information and/or question metadata are provided 822 to the host server 805. After receiving the information from the AI model 811, a request 824 is sent to one or more databases 807 of the workforce management application 800. In some embodiments, a dynamic identification and aggregation process 826 is performed at the databases 807, which may include knowledge index vector database 828, an embedding model 830, and/or usage data 832. In some embodiments, the usage data is anonymized in order to prevent data identifying the members of the workforce to be provided in an output of the AI models being queried.

Turning to FIG. 8C, the AI server 805 performs an authentication operation 834 at the host server 803 to validate user security access to the data obtained from the databases 807.

After validating the user’s access, the AI server 805 provides a knowledge base prompt 836 to summarize information to the AI endpoint 809 and/or the second AI model 813, which may be a different version of GPT than the first AI model 811.

The AI model 813 provides a textual answer to the AI server 805 (step 840), which provides the answer (and/or a modified version of the answer) to the application server 803 (step 842), and the application server 803 sends a final output to the client device 801 (step 844). In some embodiments, when the output is received by the client device 801, it in turn formats the output for a third-party client application (846) such that integrated AI module of the third-party application can provide a formatted output within the third-party application.

### Grounding Service

In some embodiments, the grounding service (e.g., the grounding service module 322) is used for querying (e.g., background queries) within the workforce-management application 100. In some embodiments, the grounding service is responsible for building up a lightweight representation of a customer’s application model and relevant data items, so the query translation step of the system can produce a query function that is as specific to the customer’s data and/or application shape as possible. In some embodiments, the grounding service performs separate queries for each respective workforce application in which the AI analysis module is integrated.

Before running the grounding service, a router LLM call can be configured to attempt to determine the type of operation that should be performed, as well as extracting likely candidates for things like the “starting entity”, metric names, dimension names, and dimension members (e.g., their associated dimensions). In some embodiments, the “hint” is then passed into the grounding service, and the system can begin a process of collecting grounding information. In some embodiments, this process includes:

Using the starting entity suggested by the grounding hint, search for analytic objects that are most similar and add them to the context;

Expanding the current context by searching for metrics and/or questions that are reachable from the current context, with the search strings coming from the current user question and hints; and

Expanding the context by searching for other object types and adding the highest-ranked results to the context, with the search strings coming from the current user question and hints.

In some embodiments, this approach can include performing a plurality of semantic searches in some cases (e.g., over 100 subqueries for a single request).

In some embodiments, one or more analytic components of the workforce management applications described herein are customizable. For example, customers can override one or more of (i) the display names and (ii) localized values of data model objects, in accordance with some embodiments. In some embodiments, the applications are configurable to add entirely new classes of data and/or extend the core data model. In addition to the application data model, customers can load large numbers of records into the analytic applications for detailed insights into their data, in accordance with some embodiments.

In some embodiments, the workforce management application is configured to allow customers to interact with the workforce management application (e.g., an analytic module) via natural language. In some embodiments, the workforce management application includes information about data of other applications, including: (i) core system data model objects; (ii) custom tenant data model objects; (iii) default example cases illustrating how to translate queries; (iv) custom per-tenant examples (“fine-tuning” examples); and/or (v) the names and basic characteristics of many dimension members from data.

Because the interface with a workforce management application is configured to be interacted with via natural language/chat, it generally cannot be assumed that the terminology, ids, and names entered by users are actually ones that exist in the customer’s system. In addition, the workforce management application may need additional context about related objects and/or entities in order to formulate a high-quality response.

To gather the data needed by the workforce management application is configured to respond to users, semantic search can be applied to customer-specific data sets that are sourced from the customer’s application data model and data versions. The system used to perform these searches is called the Semantic Index.

In some embodiments, there are multiple workflows that are configured to utilize the semantic index, which are described in more detail below.

### Ad-hoc Semantic Search

After the application server 104 resolves the query function needed to respond to a user question, that query function is passed back to the AI server 805. However, that query function only represents a “best-guess” by the LLM as to what query to run on the AI server 805. In some embodiments, the system attempts to resolve various parts of the query function string to the actual data model and/or customer data entries (e.g., a query function may reference FullName = “Bob Jones”, but the actual filter used on customer data should be FullName = “Robert Jones”).

The application server attempts to resolve the various entities referenced in the query function against the entities in the customer’s application and/or data model. Generally, it will do this by first checking for an “exact” match (e.g., looking up a metric by symbol name), with a fallback search using the application server Lucene index and then finally resorting to invoking the Semantic Search endpoints of the workforce management application to try and resolve an entity if nothing else was able to resolve it.

### Lookup Service

In some embodiments, a lookup service may also be used in conjunction with the grounding service in addition or alternatively to the ad-hoc semantic search service. In some embodiments, a router step is used to produce “hints” about potential matches for different entities from the business question 812 determined based on the user’s prompt.

In accordance with some embodiments, the hints represent a “best guess” by the LLM at what potential entities are included, and what types of entity they are (e.g., identifying that there may be a dimension member called Sales under the Department hierarchy). In some embodiments, as part of the grounding service, the system attempts to resolve the guesses to the entities they match in the tenant.

In some embodiments, the semantic search service is used to rank results provided by the AI server. In some embodiments, a hybrid search is used that incorporates several sources of ranking information for the lookup service, including but not limited to: (i) semantic similarity; (ii) full-text similarity; (iii) recency of usage; and/or (iv) frequency of usage. In some embodiments, a reciprocal rank fusion algorithm is used to control weighting factors for each of the different score types.

### Search Ranking

In accordance with some embodiments of the present disclosure, “ranking” refers to the process of identifying the most relevant documents in the Semantic Index for a particular query. Typically, this involves assigning a “score” to a document that indicates its relevance, and higher-scored documents are treated as more relevant. In accordance with some embodiments, the following ranking methodologies may be implemented by the workforce management application 100:

Semantic Ranking: In some embodiments, the core search capability needed by the semantic index is the ability to score and/or rank results based on semantic similarity. In some embodiments, this makes it possible to find elements that are not matched by exact name, but instead by their semantic meaning (e.g., Software Developer would be more semantically similar to Systems Administrator than to Tour Guide). In some embodiments, the semantic search for the workforce management application uses transformer-based text embeddings to translate query strings to a vector embedding. In some embodiments, a model used by the system is a 768-dimensional Instructor embedding that allows us to prefix queries and documents with extra context to help with domain-specificity.

Full-Text Ranking: In some embodiments, a secondary search capability that the Semantic Index requires is the ability to perform full-text search. Full-text search refers to the ability to perform searches for documents containing some query string (modulo some stemming and normalization rules). This capability can improve the efficiency of search by semantic ranking (e.g., when semantic ranking is not able to perform exact matches). In some embodiments, full-text search can allow the Semantic Index to prioritize results with exact string matches over other results, provided that the semantic similarity of the results is otherwise equal.

Hybrid Ranking: In accordance with some embodiments, hybrid search refers to the ability to run multiple searches using different approaches and then combine the various search results into a single set of results that may be more representative of the user’s intent than any of the individual result sets. In some embodiments, hybrid search is implemented at the level of the semantic index, but can also be implemented aside from the semantic search service.

Usage-Based Ranking: In accordance with some embodiments, usage-based ranking refers to the ability to rank results based on the frequency of usage of the object the result corresponds to in the one or more analytic modules of the workforce-management application. In some embodiments, if all else is within an equivalence threshold, objects that are used more frequently in the analytic app should be preferred over objects that are used less frequently. In some embodiments, this concept can be extended to grant additional weight to usage-based ranking such that objects that are very frequently-used are ranked above even more semantically similar results (e.g., due to the presence of usage data, the system may be configured to surface “worse” and/or less-similar results because of an assumption that frequently-used objects are more likely to match the user’s intent).

### Data Isolation from Foundational LLM

In some embodiments, the systems, devices, and methods described herein provide for secure query formulation. A system and method are disclosed wherein a foundational large language model (LLM) is configured to receive natural language queries from a user and to convert said natural language queries into a structured query language (e.g., a custom formula language) interpretable by a distinct analytical data model.

In some embodiments, the system is configured such that no sensitive customer data, or enterprise data is exposed to, or processed by, a foundational LLM during this query conversion process. In some embodiments, at least one of the LLMs described herein has a sole operational function is the linguistic transformation of the input query into the analytical model’s native query syntax. In some embodiments, the system is configured to ensure that the LLM operates exclusively on the linguistic representation of the query, thereby maintaining a strict isolation from the underlying data.

### Elimination of LLM-Induced Data Hallucination

In some embodiments, the systems, devices, and methods described herein provide for a guaranteed level response integrity and/or hallucination prevention. In some embodiments, the disclosed architecture is configured to inherently prevent the generation of fabricated or factually incorrect data by the LLM. Since the foundational LLM is never exposed to customer data and its primary function is strictly limited to query generation (rather than content generation based on data), the LLM cannot “hallucinate” or artificially create data that is ultimately provided to a user-facing device, in accordance with some embodiments. In some embodiments, no data is synthetically created or inferred by the LLM beyond the query itself, thereby ensuring that any returned data is verifiable and originates solely from the governed analytical data model.

### Tenant-Level Security Enforcement Independent of the LLM

In some embodiments, the systems, devices, and methods described herein are configured to provide for robust, LLM-independent security enforcement. In some embodiments, the system further comprises (e.g., at the AI server 805) a security layer that is configured to apply and enforce data access permissions at the analytical data model’s tenant level (e.g., at the AI endpoint 809), independently of the LLM.

In some embodiments, the security layer operates subsequent to the LLM’s query formulation and prior to any data retrieval from the analytical model. For example, the security layer may perform the security operations before the request 816 is provided to the AI server 805. In some embodiments, the systems and devices discussed herein are configured such that user access rights are controlled (e.g., strictly governed) by tenant permissions of the system, which can prevent and/or minimize attempts by a user to circumvent data access controls via manipulation or “gaming” of the LLM (e.g., identifying queries that are most likely to expose certain data, preventing iterative queries related to anonymized data that could effectually provide for de-anonymization of the data). In some embodiments, the system is configured to ensure that only data authorized for the specific user’s tenant-level permissions is ever retrieved or displayed. For example, as noted with respect to FIG. 8A, when a user is authenticated by the system, an authentication token 802 can be provided by the system that is specific to the user accessing the system and their respective data access rights within the workforce.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method, comprising:
at an electronic device associated with a workforce management application, the electronic device having one or more processors and memory, the memory storing instructions for causing presentation of the workforce management application:
obtaining a textual prompt at a user interface associated with a productivity application;
identifying, based on content of the textual prompt, a query within the textual prompt;
based on analyzing the query, determining whether the query is one of (i) a detail-seeking query type, requesting a set of data that is currently available within one or more respective data sources associated with the productivity application, or (ii) a panoptic query type requesting another set of data that is not currently available within the productivity application and requires aggregation of two or more respective data sources associated with the productivity application;
in accordance with a first determination that the query is of the detail-seeking query type, providing the set of data to a large-language model (LLM) to format an answer based on an attribute or metric from the set of data;
identifying, based on other content of another textual prompt, another query within the textual prompt; and
in accordance with a second determination that the other query is of the panoptic query type requires the other set of data that is not currently available, providing respective data from the two or more respective data sources to another LLM to perform an analytical function on the respective data from the two or more respective data sources.

2. The method of claim 1, further comprising:
in accordance with the second determination that the query is the panoptic query type, providing additional context data to the LLM from one or more of: (i) a vector database, (ii) an embedding model, and (iii) usage data.

3. The method of claim 1, wherein the determination whether the query is of the detail-seeking query type further comprises determining whether the query is (i) answerable with stored attributes, and/or (ii) answerable with available metrics.

4. The method of claim 1, further comprising:
in accordance with the second determination that the query is the panoptic query type, generating an index bundle based on the respective data from the two or more respective data sources that is to be provided to the other LLM.

5. The method of claim 1, further comprising:
after providing the set of data to the LLM to format the answer based on the attribute or the metric from the set of data, identifying a set of predefined panoptic queries related to the answer; and
presenting a set of user interface elements associated with one or more respective predefined panoptic queries of the set of predefined panoptic queries.

6. The method of claim 1, further comprising:
after providing the respective data from the two or more respective data sources to the other LLM to perform the analytical function on the respective data from the two or more respective data sources:
causing presentation of a visual representation provided as an output of the other LLM based on a result of the analytical function performed on the respective data.

7. The method of claim 1, further comprising:
after identifying the query within the textual prompt, determining whether one or more previous textual prompts within a thread associated with the user interface are related to the query; and
based on a determination that the one or more previous textual prompts are related to the query, using data associated with the previous textual prompts to determine whether the query is a detail-seeking query or a panoptic query.

8. A non-transitory computer-readable storage medium, comprising instructions that, when executed by one or more processors, cause the one or more processors to:
at an electronic device associated with a workforce management application, the electronic device having one or more processors and memory, the memory storing instructions for causing presentation of the workforce management application:
obtain a textual prompt at a user interface associated with a productivity application;
identify, based on content of the textual prompt, a query within the textual prompt;
based on analyzing the query, determine whether the query is one of (i) a detail-seeking query type, requesting a set of data that is currently available within one or more respective data sources associated with the productivity application, or (ii) a panoptic query type requesting another set of data that is not currently available within the productivity application and requires aggregation of two or more respective data sources associated with the productivity application;
in accordance with a first determination that the query is of the detail-seeking query type, provide the set of data to a large-language model (LLM) to format an answer based on an attribute or metric from the set of data;
identify, based on other content of another textual prompt, another query within the textual prompt; and
in accordance with a second determination that the other query is the panoptic query type requires the other set of data that is not currently available, provide respective data from the two or more respective data sources to another LLM to perform an analytical function on the respective data from the two or more respective data sources.

9. The non-transitory computer-readable storage medium of claim 8, further including instructions for causing the processor to:
in accordance with the second determination that the query is the panoptic query type, provide additional context data to the LLM from one or more of: (i) a vector database, (ii) an embedding model, and (iii) usage data.

10. The non-transitory computer-readable storage medium of claim 8, wherein the determination whether the query is of the detail-seeking query type further comprises determining whether the query is (i) answerable with stored attributes, and/or (ii) answerable with available metrics.

11. The non-transitory computer-readable storage medium of claim 8, further including instructions for causing the processor to:
in accordance with the second determination that the query is the panoptic query type, generating an index bundle based on the respective data from the two or more respective data sources that is to be provided to the other LLM.

12. The non-transitory computer-readable storage medium of claim 8, further including instructions for causing the processor to:
after providing the set of data to the LLM to format the answer based on the attribute or the metric from the set of data, identify a set of predefined panoptic queries related to the answer; and
present a set of user interface elements associated with one or more respective predefined panoptic queries of the set of predefined panoptic queries.

13. The non-transitory computer-readable storage medium of claim 8, further including instructions for causing the processor to:
after providing the respective data from the two or more respective data sources to the other LLM to perform the analytical function on the respective data from the two or more respective data sources:
causing presentation of a visual representation provided as an output of the other LLM based on a result of the analytical function performed on the respective data.

14. The non-transitory computer-readable storage medium of claim 8, further including instructions for causing the processor to:
after identifying the query within the textual prompt, determine whether one or more previous textual prompts within a thread associated with the user interface are related to the query; and
based on a determination that the one or more previous textual prompts are related to the query, use data associated with the previous textual prompts to determine whether the query is a detail-seeking query or a panoptic query.

15. A system, comprising:
one or more processors; and
memory, comprising instructions that, when executed by the one or more processors, causing the system to:
at an electronic device associated with a workforce management application, the electronic device having one or more processors and memory, the memory storing instructions for causing presentation of the workforce management application:
obtain a textual prompt at a user interface associated with a productivity application;
identify, based on content of the textual prompt, a query within the textual prompt;
based on analyzing the query, determine whether the query is one of (i) a detail-seeking query type, requesting a set of data that is currently available within one or more respective data sources associated with the productivity application, or (ii) a panoptic query requesting another set of data that is not currently available within the productivity application and requires aggregation of two or more respective data sources associated with the productivity application;
in accordance with a first determination that the query is of the detail-seeking query type, providing the set of data to a large-language model (LLM) to format an answer based on an attribute or metric from the set of data;
identifying, based on other content of another textual prompt, another query within the textual prompt; and
in accordance with a second determination that the other query is the panoptic query requires the other set of data that is not currently available, providing respective data from the two or more respective data sources to another LLM to perform an analytical function on the respective data from the two or more respective data sources.

16. The system of claim 15, wherein the memory further comprises instructions for causing the one or more processors to:
in accordance with the second determination that the query is the panoptic query, providing additional context data to the LLM from one or more of: (i) a vector database, (ii) an embedding model, and (iii) usage data.

17. The system of claim 15, wherein the determination whether the query is of the detail-seeking query type further comprises determining whether the query is (i) answerable with stored attributes, and/or (ii) answerable with available metrics.

18. The system of claim 15, wherein the memory further comprises instructions for causing the one or more processors to:
in accordance with the second determination that the query is the panoptic query, generating an index bundle based on the respective data from the two or more respective data sources that is to be provided to the other LLM.

19. The system of claim 15, wherein the memory further comprises instructions for causing the one or more processors to:
after providing the set of data to the LLM to format the answer based on the attribute or the metric from the set of data, identifying a set of predefined panoptic queries related to the answer; and
presenting a set of user interface elements associated with one or more respective predefined panoptic queries of the set of predefined panoptic queries.

20. The system of claim 15, wherein the memory further comprises instructions for causing the one or more processors to:
after providing the respective data from the two or more respective data sources to the other LLM to perform the analytical function on the respective data from the two or more respective data sources:
causing presentation of a visual representation provided as an output of the other LLM based on a result of the analytical function performed on the respective data.
